(19) United States
(12) Patent Application Publication
(10) Pub. No.: US 2024/0383629 A1
(43) Pub. Date: Nov. 21, 2024

(54) METHOD AND DEVICE FOR REMEDYING DISTURBANCES IN A FILLING AND/OR SEALING AND/OR POST-PROCESSING INSTALLATION

(71) Applicant: OPTIMA pharma GmbH, Schwäbisch Hall (DE)

(72) Inventors: Jürgen Rothbauer, Michelfeld (DE); Matthias Poslovski, Schwäbisch Hall (DE); Thomas Pospiech, Erlenbach (DE); Julian Schweigert, Schwäbisch Hall (DE); Matthias Hofmann, Ilshofen (DE); Waldemar Mayer, Schwäbisch Hall (DE); Florian Weippert, Schwäbisch Hall (DE)

(73) Assignee: OPTIMA pharma GmbH, Schwäbisch Hall (DE)

(21) Appl. No.: 18/694,602

(22) PCT Filed: Sep. 22, 2022
(86) PCT No.: PCT/EP2022/076379

§ 371 Date: Mar. 22, 2024

(30) Foreign Application Priority Data
Sep. 27, 2021 (DE) 10 2021 210 750.8

(51) Int. Cl. B65B 57/08; B25J 9/16; B65B 3/00

(52) U.S. Cl. CPC B65B 57/08; B25J 9/1666; B65B 3/003

(57) ABSTRACT

The invention relates to a method and a device for handling of disturbances in a filling and/or closing and/or post-processing installation for the pharmaceutical industry using a manipulator (14), wherein a path along which the manipulator (14) is moved for collision-free handle of the disturbance is planned in such a way that travel paths of the manipulator (14) which influence a primary air supply (5) of primary packaging means and/or of components of the filling and/or closing and/or post-processing installation which are in contact with the primary packaging means are minimized. The invention further relates to a filling and/or closing and/or post-processing installation and a computer program for a filling and/or closing and/or post-processing installation.

### FIELD OF APPLICATION AND PRIOR ART

The invention relates to a method and a device for handling of disturbances, in particular rectifying of disturbances, in a filling and/or closing and/or post-processing installation for the pharmaceutical industry. The invention further relates to a computer program for a filling and/or closing and/or post-processing installation.

Filling and/or closing installations for the pharmaceutical industry are used for filling liquid or powder-form pharmaceutical and biopharmaceutical products into containers such as small bottles (vials), infusion bottles, carpules, disposable syringes or the like, the containers being closed using a closure such as, for example, a stopper and/or a cap, as far as possible immediately after filling and any subsequent inspection. In the context of the application, containers and closures are referred to as primary packaging means. Post-processing installations are used, for example, for inspection, labelling, repackaging or other handling of the filled, and usually already closed, primary packaging means.

Filling of sensitive or hazardous products in this case is usually performed in an isolator. In addition, installations without an isolator for filling or post-processing of pharmaceuticals and/or other products are also known.

Disturbances or faults in the process flow of filling and closing and/or of post-processing can result in stoppage of the installation. However, particularly when small batches are processed in a filling and/or closing installation and/or a post-processing installation, it is highly desirable to avoid stoppage times if possible. Moreover, an unplanned stoppage of a filling and/or closing installation and/or post-processing installation can have the consequence that the products can no longer be used. This applies in particular—but not exclusively—to sensitive biopharmaceutical products.

### OBJECT AND SOLUTION

Objects of the invention are to provide a method and a device for the automated handling of disturbances in a filling and/or closing and/or post-processing installation for the pharmaceutical industry using a manipulator. It is a further object to create a computer program for the automated handling of disturbances in a filling and/or closing and/or post-processing installation for the pharmaceutical industry using a manipulator.

These objects are achieved by the subjects having the features of claims 1, 7 and 12. Further advantageous embodiments result from the dependent claims.

According to a first aspect, a method is provided for handling of disturbances in a filling and/or closing and/or post-processing installation for the pharmaceutical industry using a manipulator, wherein a path along which the manipulator is moved for collision-free handling of the disturbance is planned in such a way that travel paths of the manipulator which influence a primary air supply to primary packaging means and/or to components of the filling and/or closing and/or post-processing installation which are in contact with the primary packaging means are minimized.

In the context of the application, the terms “a” and “an” are used as indefinite articles and not as counting terms. In particular, in embodiments a plurality of manipulators are provided, which can be used selectively to handle specific disturbances.

In the context of the application, the term “disturbances” is generally used to describe an irregularity in a process flow, wherein, depending on the embodiment, the disturbance has already led to a stoppage of the installation or a fault in the process flow, the disturbance is detected and handled, in particular rectified, before a stoppage of the installation or a fault in the process flow occurs, and/or the disturbance has no influence on the immediate process flow. In an embodiment, the disturbance may be an irregularity in a transport or an infeed or outfeed of the primary packaging means, for example an incorrectly oriented primary packaging means, a missing primary packaging means or an excess primary packaging means. In an embodiment, a presence check of primary packaging means is provided, for example, to determine whether primary packaging means are present in an infeed region in a sufficient quantity and/or whether no primary packaging means are present in an outfeed region, so that it is possible to deposit primary packaging means in this region. An unplanned presence or absence of primary packaging means is referred to as a disturbance.

For example, in an embodiment, paths of a manipulator are planned for handling of disturbances in a sorting device and/or a single-track or multi-track transport, infeed and/or outfeed region for primary packaging means, for example in a transport, infeed and/or outfeed region for closing plugs and/or containers, wherein the disturbances include, among other things, blockages or gaps in the transport, infeed and/or outfeed region, and missing, incorrectly oriented and/or incorrectly positioned primary packaging means. The expression “incorrectly oriented primary packaging means” is used for primary packaging means that have fallen over, are twisted or have been fed upside down, which may cause a fault and/or a stoppage during further processing. The expression “incorrectly positioned primary packaging means” is used for primary packaging means that are in a position other than that intended.

In another embodiment, paths of a manipulator are planned for handling of disturbances in a transport, infeed and/or outfeed region in which primary packaging means are provided or deposited in a disordered manner or ordered in a matrix (nest), in particular disturbances to a spatially delimited tray for primary packaging means or in an infeed and/or outfeed region, comprising in embodiments said nest, from which primary packaging means are removed or into which primary packaging means are placed. The disturbances to be handled include missing, overlying, incorrectly oriented or incorrectly positioned primary packaging means. Primary packaging means which rest on other primary packaging means or on a nest or the like are referred to as overlying primary packaging means.

For a path planning of manipulators, two cases can be distinguished in principle. In the first case, the path of the manipulator is already known or predetermined due to general conditions, wherein a movement and/or speed course of the manipulator along this path can be optimized for certain requirements. In a second case, only the start and end points of the path are known, wherein path planning is performed with the inclusion of further criteria.

The first case can be used in a filling and/or closing and/or post-processing installation in an embodiment for handling of disturbances in a region in which primary packaging means are arranged in a defined matrix, for example in a nest. The nest has a closed number of positions, wherein a path can be defined in advance for approaching each position and/or a manipulator with a limited number of degrees of freedom can be used and can be moved exclusively into the defined positions. Depending on the application, however, path planning for handling of disturbances in a nest without predefined paths is also advantageous. In an embodiment, path planning is performed in advance of process implementation, wherein the manipulator is moved along the path defined in advance when a disturbance occurs. In other embodiments, path planning is performed situationally after the occurrence of a disturbance.

The second case of path planning can be used in a filling and/or closing and/or post-processing installation for handling of disturbances in a region in which primary packaging means are arranged chaotically or almost chaotically, for example in a disordered manner on a tray or on several tracks. Such regions do not have a definitive number of positions which are to be approached by the manipulator. In particular, it is also conceivable that different tracks are optimal for two end positions that are arranged adjacently or in overlapping fashion, taking into account certain criteria.

In an embodiment, the path along which the manipulator is moved for collision-free handling of the disturbance is autonomously planned using a computing unit, i.e. without interaction with an operator. Pharmaceutical path planning can differ from conventional path planning methods due to a selection of criteria and/or due to a weighting of the criteria. For example, in typical path planning tasks, the time that the manipulator needs to move between a starting point and an end point is usually minimized. For pharmaceutical path planning, however, other criteria are relevant, wherein at least travel paths of the manipulator are planned in such a way that an influence on a primary air supply is minimized or prevented.

In the context of the application, primary air supply means an air supply from a source or a filter, in particular a high-efficiency particulate air filter (HEPA filter for short), in a unidirectional air flow that is at least substantially particle-free. Depending on the application, a marginal influence on the primary air supply is tolerable or any influence detectable with known measuring methods is classified as a disturbance of the primary air supply. In particular for processing sensitive products in an isolator or under a fume cupboard, contamination is to be prevented by an at least almost exclusive primary air supply to the primary packaging means and the components of the installation which are in contact with the primary packaging means.

In order to avoid influencing the primary air supply of primary packaging means and/or of components of the filling and/or closing and/or post-processing installation which are in contact with primary packaging means, in an embodiment, travel paths above these primary packaging means and/or components are minimized in the case of a primary air supply from a ceiling region.

In embodiments of the invention, a pharmaceutically compliant path planning is carried out taking into account further criteria, wherein criteria for a pharmaceutical compliance are in particular selected from a group comprising minimization of a time for which the manipulator is arranged above primary packaging means, minimization of a time for which the manipulator is arranged above components of the filling and/or closing and/or post-processing installation which are in contact with the primary packaging means, flow optimization of a movement and/or speed profile, minimization of a rotation of axes of the manipulator, minimization of a movement of a handling system of the manipulator above the primary packaging means and/or the components of the filling and/or closing and/or post-processing installation which are in contact with primary packaging means, in particular minimization of a gripper movement above the primary packaging means, and minimization of an impact surface in a primary air supply. The individual criteria are to be suitably weighted and/or supplemented by a person skilled in the art depending on the application.

By minimizing rotation of axes of the manipulator, in embodiments abrasion on the axes can be minimized.

Minimization of an impact surface in a primary air supply is defined as a positioning of the manipulator by which surfaces of the manipulator perpendicular to the air flow of the primary air supply are minimized. Minimization is possible, for example, in the form that-if not completely avoidable-only small surfaces, for example surfaces of a gripper, are positioned in the air flow, but not larger surfaces of an arm of the manipulator.

In an embodiment, the path is planned using an algorithm that is optimized for pharmaceutical compliance. In an embodiment, the algorithm is an optimization algorithm. In an embodiment, the algorithm is evolutionary. In an embodiment, the parameters are changed and/or adjusted in several iterations.

Alternatively or additionally, the path is planned using an artificial intelligence model (AI model) that is trained for pharmaceutical compliance.

In an embodiment, the path is visualized on a monitor in a digital image of the environment. In other words, the monitor shows a digital twin of the manipulator and its real environment. In an embodiment, the path is visualized for interactive correction and/or approval before the manipulator is moved. For a correction of the planned path, in an embodiment it is provided that the operator can change individual path points, wherein in an embodiment a touch-sensitive monitor is provided for this purpose. Alternatively or additionally, for a correction in an embodiment, a repetition of the path planning can be triggered by an operator without changing the criteria or their weighting. In other embodiments, it is possible for an operator to optionally repeat the path planning by changing the criteria and/or their weighting. In yet other embodiments, no interaction of the operator is necessary for an approval of the planned path. In an embodiment, an evaluation of the quality of the planned path is carried out, wherein no interaction of an operator is required if a defined threshold value is exceeded in the evaluation. In an embodiment, the path planning is first automatically repeated if the value drops below the threshold value, and an interaction of an operator is only required if the value drops below the threshold value again. Alternatively or additionally, a real movement of the manipulator is visualized on the monitor in the digital image of the environment.

In an embodiment, the path along which the manipulator is moved is electronically logged. Data to be logged concerning the path, the cause for a movement of the manipulator, primary packaging means moved using the manipulator, or the like can be suitably determined by a person skilled in the art depending on the application. In an embodiment, it is logged over what period of time and/or with what coverage the manipulator was moved in the primary air supply. In an embodiment, the logged data comprise a video file of the movement visualized on the monitor, i.e. a video file of the digital twin. The video file allows easy evaluation of the performed movement by an operator.

Alternatively or additionally, in an embodiment, primary packaging means and/or the components of the filling and/or closing and/or post-processing installation which are in contact with primary packaging means over which the manipulator is moved along the path are identified and/or marked. In advantageous embodiments, these primary packaging means and/or these components are marked exclusively in electronic form. In an embodiment, it is provided that identified and/or marked primary packaging means are removed from the process and/or fed to an inspection or to a post-treatment. In an embodiment, threshold values are defined for time periods in which the manipulator was above certain primary packaging means and/or components, wherein in an embodiment, if the threshold values are exceeded, automatic removal from the process takes place and/or a message is sent to an operator, who decides on subsequent measures.

In an embodiment, the path is planned taking into account interference contours of an environment. A path planning for an autonomous movement of the manipulator is performed in such a way that a planned path does not cross the interference contours. In an embodiment, virtual interference contours are also defined in order to prevent the manipulator from approaching or crossing positions that influence process reliability. In advantageous configurations, the interference contours are defined differently for different regions.

In an embodiment, the manipulator has a gripper, in particular a servo gripper, a vacuum gripper, a pneumatic gripper and/or a magnetically driven gripper. In an embodiment, objects of different sizes can be gripped using the gripper, wherein it can be detected via a current consumption and/or a position whether the object, in particular a primary packaging means, has been gripped. In another embodiment, tactile sensors are provided on the gripper and are used to detect whether an object has been gripped. In yet other embodiments, monitoring is carried out using a camera system.

Depending on the application, the manipulator has another handling means instead of a gripper, for example a passive handling means such as a hook.

In an embodiment, it is provided that in the handling region of a distal end of the manipulator, in particular of a gripper of the manipulator, no or only a minimal interference contour of the environment is provided. In order to avoid a collision of the distal end of the gripper with an environment, virtual distance sensors are provided at the distal end in an embodiment, which are configured to detect a distance of the distal end from the environment in a digital image of the moving manipulator and the environment. In an embodiment, in particular for a visualization for inspecting the movement on a monitor and/or for a movement of the manipulator using a manually operable control, it is provided that a speed of the manipulator decreases with decreasing distance. The decreasing speed increases a sensitivity for the movement of the manipulator. In order to approximate a digital image of the environment to the real environment, it is provided in an embodiment that the manipulator detects individual points of the real environment using suitable sensors, in particular using laser sensors, and synchronizes the digital environment with the real environment. In order to generate a digital image of the environment, it is provided in an embodiment that the manipulator detects the real environment using suitable sensors, in particular using laser sensors.

According to a second aspect, a device for handling of disturbances in a filling and/or closing and/or post-processing installation for the pharmaceutical industry with a manipulator is provided, comprising a computing unit configured to plan a path along which the manipulator is movable to handle the disturbance, wherein the path is planned in such a way that travel paths of the manipulator which influence a primary air supply to primary packaging means and/or to components of the filling and/or closing and/or post-processing installation which are in contact with the primary packaging means are minimized.

In an embodiment, the computing unit is part of a control device of the filling and/or closing and/or post-processing installation. In other embodiments, a separate computing unit is provided, wherein the separate computing unit is in embodiments in communication with the control device of the filling and/or closing and/or post-processing installation for data exchange.

In an embodiment, the computing unit is configured to plan the path using an algorithm optimized for pharmaceutical compliance, wherein criteria for pharmaceutical compliance are in particular selected from a group comprising minimization of a time for which the manipulator is arranged above primary packaging means, minimization of a time for which the manipulator is arranged above components of the filling and/or closing and/or post-processing installation which are in contact with the primary packaging means, flow optimization of a movement and/or speed profile, minimization of a rotation of axes of the manipulator, minimization of a movement of a handling system of the manipulator above the primary packaging means and/or the components of the filling and/or closing and/or post-processing installation which are in contact with primary packaging means, in particular minimization of a gripper movement above the primary packaging means, and minimization of an impact surface in the primary air supply.

Alternatively or additionally, the computing unit is configured to plan the path using an artificial intelligence model (AI model) trained for pharmaceutical compliance, wherein criteria for pharmaceutical compliance are in particular selected from a group comprising minimization of a time for which the manipulator is arranged above primary packaging means, minimization of a time for which the manipulator is arranged above components of the filling and/or closing and/or post-processing installation which are in contact with the primary packaging means, flow optimization of a movement and/or speed profile, minimization of a rotation of axes of the manipulator, minimization of a movement of a handling system of the manipulator above the primary packaging means and/or the components of the filling and/or closing and/or post-processing installation which are in contact with primary packaging means, in particular minimization of a gripper movement above the primary packaging means, and minimization of an impact surface in the primary air supply.

In an embodiment, the computing unit is configured to transmit data to a monitor so that the path can be visualized on the monitor in a digital image of the environment. In an embodiment, the monitor is located on the filling and/or closing and/or post-processing installation. In other embodiments, a separate monitor is provided, for example a monitor of a portable communication terminal, such as a tablet computer or a smartphone, wherein the planned path can be visualized to the operator at a location spatially remote from the filling and/or closing and/or post-processing installation. In an embodiment, the visualization of the path is possible before a movement of the manipulator is performed for an interactive correction and/or an approval. Alternatively or additionally, a real movement of the manipulator can be visualized, in advantageous embodiments in real time, on the monitor in the digital image of the environment. In an embodiment, the operator can stop or otherwise influence the movement of the manipulator if necessary.

In an embodiment, the computing unit is configured to transmit data to a memory unit so that the path along which a movement of the manipulator is performed can be logged in the memory unit, wherein in particular it can be logged over what period of time and/or with what coverage the manipulator was moved in the primary air supply, and/or that the computing unit is configured to identify and/or mark primary packaging means and/or components of the filling and/or closing and/or post-processing installation which are in contact with primary packaging means over which the manipulator is moved along the path.

In an embodiment, the memory unit is formed as a common unit with the computing unit. In other embodiments, an external memory unit is provided, for example a central memory unit in a network, which can be accessed by authorized persons via the network.

According to a third aspect, a computer program is created which comprises instructions which, when the program is run by a computing unit, cause the computing unit to plan a path along which a manipulator is moved for collision-free handling of a disturbance so as to minimize travel paths of the manipulator which influence a primary air supply to primary packaging means and/or to components of a filling and/or closing and/or post-processing installation which are in contact with the primary packaging means.

### BRIEF DESCRIPTION OF THE DRAWINGS

Further advantages and aspects of the invention will become apparent from the claims and from the description of exemplary embodiments of the invention, which are explained below with reference to the figures, in which:

FIG. 1: shows schematically a device for handling of disturbances in a filling and/or closing and/or post-processing installation with an infeed region; and

FIG. 2: shows schematically a device for determining and handling of disturbances in a filling and/or closing and/or post-processing installation with an infeed region.

### DETAILED DESCRIPTION OF THE EXEMPLARY EMBODIMENTS

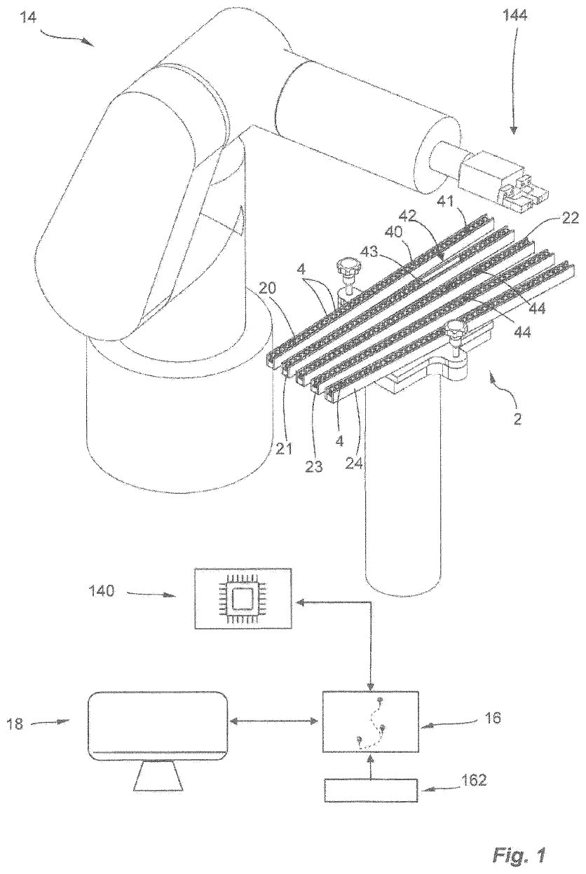

FIG. 1 schematically shows an infeed region 2 of a filling and/or closing and/or post-processing installation not shown in detail and a device 1 comprising a computing unit 16 and a monitor 18 for handling of disturbances in the infeed region 2 using a manipulator 14. All elements are shown merely schematically in FIG. 1 and the sizes shown do not correspond to real sizes.

The infeed region 2 shown has a plurality of linearly running tracks 20, 21, 22, 23, 24 for primary packaging means 4 in the form of closing plugs. The tracks 20, 21, 22, 23, 24 are each laterally delimited. The dimensions of the tracks 20, 21, 22, 23, 24 are selected in such a way that the primary packaging means 4 can each be moved in a row one behind the other along the tracks 20, 21, 22, 23, 24.

The manipulator 14 has, at its distal end, a schematically shown gripper 144, using which the primary packaging means 4 can be gripped.

In FIG. 1, a plurality of disturbances in the infeed region 2 are shown schematically. The disturbances shown are incorrectly oriented primary packaging means 40, 41, 44, and a gap 42, wherein the gap 42 has arisen, for example, due to a primary packaging means 43 blocking the movement in the track 20. In detail, in the track 20 on the left in the drawing plane, a primary packaging means 40 is shown rotated through 180° or fed upside down and a primary packaging means 41 is shown tilted in the track direction. In the second track 21 from the left, a gap 42 is shown. In the middle track 22, a primary packaging means 41 that has fallen over in the track direction and a primary packaging means 44 oriented transversely to the track direction are shown. A primary packaging means 44 oriented transversely to the track direction is also shown in the second track 23 from the right. The right-hand track 24 is filled completely correctly.

The disturbances are handled using the manipulator 14.

The device 1 comprises a computing unit 16, which is configured to plan a path along which the manipulator 14 is movable in order to handle the disturbance, wherein the path is planned in such a way that travel paths of the manipulator 14 which disturb a primary air supply 5 of the primary packaging means and/or of the components which are in contact with the primary packaging means, i.e. the paths 20, 21, 22, 23, 24 in the illustrated exemplary embodiment, are minimized.

In an embodiment, the computing unit 16 is configured to perform a pharmaceutically compliant path planning for a collision-free movement autonomously, i.e. without interaction with an operator. Path planning is performed here under consideration of interference contours 162. The data for the planned path can be transmitted to a machine controller 140 of the manipulator 14 for an automated movement.

In the exemplary embodiment shown, a monitor 18 is provided, on which the planned path can be visualized in a digital image of the environment. In an embodiment, it is provided that the planned path is visualized on the monitor 18 before a movement of the manipulator 14. In an embodiment, the operator can approval a planned path or initiate a correction of the planned path. In an embodiment, data concerning the planned path are stored for logging, so that an evaluation of the performed movement is subsequently possible.

In an embodiment, a real movement of the manipulator 14 is also visualized on the monitor 18 in the digital image of the environment. This makes it possible to monitor the movement on the monitor 18, wherein the monitor 18 can be arranged spatially separately from the manipulator 14.

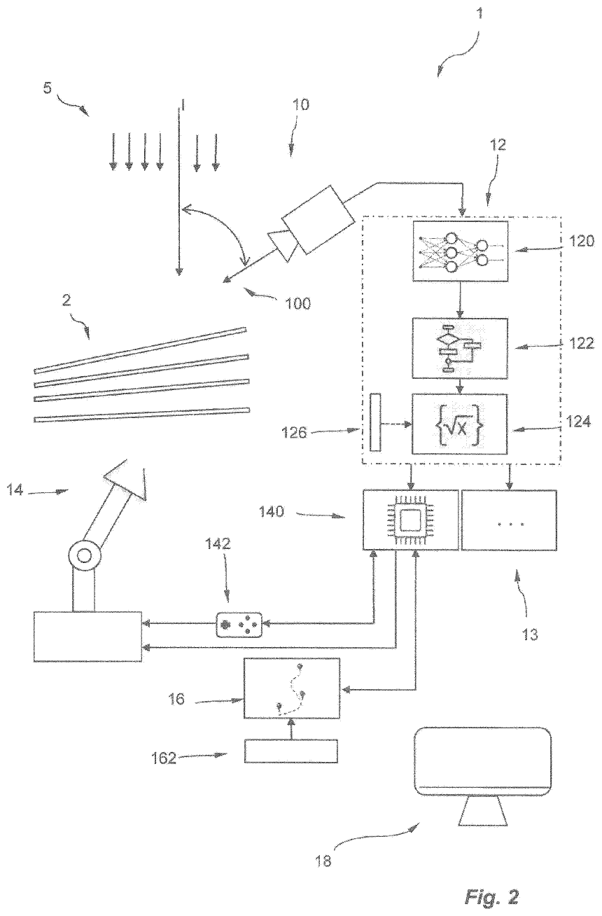

FIG. 2 schematically shows a device 1 for monitoring a filling and/or closing and/or post-processing installation with a transport, infeed and/or outfeed region 2 using a camera system 10 and a computing unit 12 and for handling in automated fashion a detected disturbance using a manipulator 14.

The camera system 10 is configured to take an image or a sequence of images of the transport, infeed and/or outfeed region 2. In the exemplary embodiment shown, an optical axis 100 of the camera system 10 is arranged obliquely to a vertical axis I, wherein the camera system 10 is arranged above the transport, infeed and/or outfeed region 2, offset in relation thereto in such a way that a primary air supply 5 of the transport, infeed and/or outfeed region 2, indicated schematically by arrows, is not disturbed from above by the camera system 10.

The computing unit 12 is configured to detect a disturbance on the basis of the image taken by the camera system using an AI model 120 and using a rule-based algorithm 122. In an embodiment, it is additionally provided to classify the detected disturbance using the rule-based algorithm 122, i.e. to assign the detected disturbance to a class and to prioritize the detected disturbance, i.e. to assign a priority value to the detected disturbance.

The computing unit 12 is also configured to locate the disturbance, i.e. to identify a position of the detected disturbance in the transport, infeed and/or outfeed region 2. For this purpose, in the exemplary embodiment shown, on the basis of a coordinate transformation 124, the position of the disturbance detected in the image plane of the camera system 10 and the dimensions and orientation of the object to be manipulated in order to handle the disturbance, in particular a primary packaging means, are transformed into a coordinate system of the manipulator 14 and/or an operator using a suitable mathematical model 126.

In an embodiment, the transformed data of the position of the disturbance as well as data concerning the primary packaging means involved, such as its dimensions and/or orientation, and—if available—a classification and/or prioritization of the detected disturbance are transmitted to a machine controller 140. In the illustrated exemplary embodiment, the machine controller 140 is in communication with a computing unit 16, which plans a path for a movement of the manipulator 14 to handle the disturbance based on the data determined by the computing unit 12 and taking into account interference contours 160. In the illustrated exemplary embodiment, the computing unit 16 is formed separately from the computing unit 12 of the monitoring system. In other embodiments, the computing units 12, 16 are formed together.

A path along which the manipulator 14 is moved for collision-free handling of the detected disturbance is planned, in an embodiment, in such a way that travel paths of the manipulator 14 which influence the primary air supply 5 of the primary packaging means and/or the components of the filling and/or closing installation and/or post-processing installation which are in contact with the primary packaging means are minimized.

In an embodiment, the path is planned using an algorithm optimized for pharmaceutical compliance, wherein criteria for pharmaceutical compliance are in particular selected from a group comprising minimization of a time for which the manipulator is arranged above primary packaging means, minimization of a time for which the manipulator is arranged above components of the filling and/or closing installation and/or post-processing installation which are in contact with primary packaging means, flow optimization of a movement and/or speed profile, minimization of a rotation of axes of the manipulator, minimization of a movement of a handling system of the manipulator above the primary packaging means and/or the components of the filling and/or closing and/or post-processing installation which are in contact with primary packaging means, in particular minimization of a gripper movement above the primary packaging means, and minimization of an impact surface in the primary air supply.

The individual criteria are to be weighted or additional criteria are to be added depending on the application.

In the exemplary embodiment shown, a monitor 18 is also provided, which is part of the device 1 or is in communication therewith for data exchange. In an embodiment it is provided that a planned path can be visualized on the monitor 18 in a simulated environment. In other words, the monitor 18 shows a digital twin of the manipulator 14 and its real environment. In an embodiment, the planned path is visualized here on the monitor 18 before the movement of the manipulator 14 is carried out for interactive correction and/or approval. For a correction of the planned path, in an embodiment it is provided that the operator can change individual path points, wherein for this purpose in an embodiment a touch-sensitive monitor 18 is provided. Alternatively or additionally, for a correction in an embodiment, a repetition of the path planning using the computing unit 16 can be triggered by an operator without changing the criteria or their weighting. In other embodiments, it is possible for an operator to optionally repeat the path planning by changing the criteria and/or their weighting. In yet other embodiments, no operator interaction is necessary for approval of the planned path. In an embodiment, an evaluation of the quality of the planned path is performed, wherein no interaction of an operator is required if a defined threshold value is exceeded in the evaluation. In an embodiment, the path planning is first automatically repeated if the value drops below the threshold value, and an interaction of an operator is only required if the value drops below the threshold value again. Alternatively or additionally, a real movement of the manipulator is visualized on the monitor in the simulated environment.

In the illustrated exemplary embodiment, a manually operable controller 142 is further provided, wherein the manipulator 14 is movable by an operator using the controller 142 to handle a disturbance.

In an embodiment, the path along which the manipulator 14 is moved autonomously or using the controller 142 is electronically logged, in particular in the memory unit 13. Data to be logged concerning the path, the cause for a movement of the manipulator 14, primary packaging means moved using the manipulator, or the like can be suitably determined by a person skilled in the art depending on the application. In an embodiment, it is logged over what period of time and/or with what coverage the manipulator was moved in the primary air supply 5. In an embodiment, the logged data comprise a video file of the movement visualized on the monitor 18, i.e. a video file of the digital twin. The video file allows easy evaluation of the performed movement by an operator.

1. A method for handling of disturbances in a filling and/or closing and/or post-processing installation for the pharmaceutical industry using a manipulator, wherein a path along which the manipulator is moved for collision-free handling of the disturbance is planned in such a way that travel paths of the manipulator which influence a primary air supply to primary packaging means and/or to components of the filling and/or closing and/or post-processing installation which are in contact with the primary packaging means are minimized.

2. The method according to claim 1, wherein the path is planned using an algorithm that is optimized for pharmaceutical compliance, wherein criteria for pharmaceutical compliance are in particular selected from a group comprising minimization of a time for which the manipulator is arranged above primary packaging means, minimization of a time for which the manipulator is arranged above components of the filling and/or closing and/or post-processing installation which are in contact with primary packaging means, flow optimization of a movement and/or speed profile, minimization of a rotation of axes of the manipulator, minimization of a movement of a handling system of the manipulator above the primary packaging means and/or the components of the filling and/or closing and/or post-processing installation which are in contact with primary packaging means, in particular minimization of a gripper movement above the primary packaging means, and minimization of an impact surface in the primary air supply.

3. The method according to claim 1 wherein the path is planned using an artificial intelligence model (Almodel) trained for pharmaceutical compliance, wherein criteria for pharmaceutical compliance are in particular selected from a group comprising minimization of a time for which the manipulator is arranged above primary packaging means, minimization of a time for which the manipulator is arranged above components of the filling and/or closing and/or post-processing installation which are in contact with the primary packaging means, flow optimization of a movement and/or speed profile, minimization of a rotation of axes of the manipulator, minimization of a movement of a handling system of the manipulator above the primary packaging means and/or the components of the filling and/or closing and/or post-processing installation which are in contact with primary packaging means, in particular minimization of a gripper movement above the primary packaging means, and minimization of an impact surface in the primary air supply.

4. The method according to claim 1, wherein the path is visualized on a monitor in a digital image of the environment, wherein in particular the path is visualized before a movement of the manipulator is performed for an interactive correction and/or an approval, and/or areal movement of the manipulator is visualized on the monitor in the digital image of the environment.

5. The method according to claim 1, wherein the path along which the manipulator is moved is electronically logged, wherein in particular it is logged over what period of time and/or with what coverage the manipulator was moved in the primary air supply, and/or in that primary packaging means and/or components of the filling and/or closing and/or post-processing installation which are in contact with primary packaging means over which the manipulator is moved along the path are identified and/or marked.

6. The method according to claim 1, wherein the path is planned taking into account interference contours of an environment and/or a distance of a distal end of the manipulator is detected using virtual distance sensors, wherein the virtual distance sensors are configured to detect a distance of the distal end to the environment in a digital image of the moving manipulator and the environment.

7. A device for handling of disturbances in a filling and/or closing and/or post-processing installation for the pharmaceutical industry with a manipulator, comprising a computing unit configured to plan a path along which the manipulator is movable to handle the disturbance, wherein the path is planned in such a way that travel paths of the manipulator which influence a primary air supply to primary packaging means and/or to components of the filling and/or closing and/or post-processing installation which are in contact with the primary packaging means are minimized.

8. The device according to claim 7, wherein the computing unit is configured to plan the path using an algorithm optimized for pharmaceutical compliance, wherein criteria for pharmaceutical compliance are in particular selected from a group comprising minimization of a time for which the manipulator is arranged above primary packaging means, minimization of a time for which the manipulator is arranged above components of the filling and/or closing and/or post-processing installation which are in contact with the primary packaging means, flow optimization of a movement and/or speed profile, minimization of a rotation of axes of the manipulator, minimization of a movement of a handling system of the manipulator above the primary packaging means and/or the components of the filling and/or closing and/or post-processing installation which are in contact with primary packaging means, in particular minimization of a gripper movement above the primary packaging means, and minimization of an impact surface in the primary air supply.

9. The device according to claim 7, wherein the computing unit is configured to plan the path using an artificial intelligence model (AI model) trained for pharmaceutical compliance, wherein criteria for pharmaceutical compliance are in particular selected from a group comprising minimization of a time for which the manipulator is arranged above primary packaging means, minimization of a time for which the manipulator is arranged above components of the filling and/or closing and/or post-processing installation which are in contact with the primary packaging means, flow optimization of a movement and/or speed profile, minimization of a rotation of axes of the manipulator, minimization of a movement of a handling system of the manipulator above the primary packaging means and/or the components of the filling and/or closing and/or post-processing installation which are in contact with primary packaging means, in particular minimization of a gripper movement above the primary packaging means, and minimization of an impact surface in the primary air supply.

10. The device according to claim 7, wherein the computing unit is configured to transmit data to a monitor so that the path can be visualized on the monitor in a digital image of the environment, wherein in particular the path can be visualized before a movement of the manipulator is carried out for an interactive correction and/or an approval, and/or a real movement of the manipulator can be visualized on the monitor in the digital image of the environment.

11. The device according to claim 7, wherein the computing unit is configured to transmit data to a memory unit so that the path along which a movement of the manipulator is performed can be logged in the memory unit, wherein in particular it can be logged over what period of time and/or with what coverage the manipulator was moved in the primary air supply, and/or in that the computing unit is configured to identify and/or mark primary packaging means and/or components of the filling and/or dosing and/or post-processing installation which are in contact with primary packaging means over which the manipulator is moved along the path.

12. A computer program comprising instructions which, when the program is run by a computing unit, cause the computing unit to carry out the method according to claim 1.
